(19) United States
(12) Patent Application Publication
(10) Pub. No.: US 2008/0276749 A1
(43) Pub. Date: Nov. 13, 2008

(54) Accelerator pedal for a vehicle

(76) Inventors: David Stewart, Malton (GB); Murray Kaijala, Elkhart, IN (US); Tad Miller, Elkhart, IN (US)

Correspondence Address: Daniel J. Deneufbourg, Esq.;CTS Corporation, 171 Covington Drive, Bloomingdale, IL, 60108, US

(21) Appl. No.: 12/151,652

(22) Filed: May 8, 2008

Related U.S. Application Data
(60) Provisional application No. 60/928,430, filed on May 9, 2007.
(60) Provisional application No. 61/066,552, filed on Feb. 21, 2008.

(51) Int. Cl. G05G 1/30

(52) U.S. Cl. 74/512

(57) ABSTRACT

A pedal assembly for a vehicle including a pedal housing and a pedal arm coupled to the housing. A friction generating assembly associated with the housing includes at least an actuator which is engaged by the pedal arm, a brake pad engaged by the actuator, and springs which engage against the brake pad. Arms on the brake pad are adapted to engage with either an interior central wall or interior peripheral wall of the friction generating assembly. In one embodiment, the friction generating assembly defines a separate module which is snap fitted into a cavity defined in the pedal housing. A magnet is coupled to the pedal arm. A sensor is coupled to the pedal housing and positioned in proximity to the magnet. The sensor is responsive to movement of the magnet to generate an electrical signal that is representative of the position of the pedal arm.

### CROSS-REFERENCE TO RELATED APPLICATIONS

This application claims the benefit of the filing dates and disclosures of U.S. Provisional Application Ser. No. 60/928,430, filed on May 9, 2007; and U.S. Provisional Application Ser. No. 61/066,552, filed on Feb. 21, 2008 which are explicitly incorporated herein by reference as are all references cited therein.

### FIELD OF THE INVENTION

This invention relates to a pedal mechanism. In particular, the pedal may be a vehicle accelerator pedal.

### BACKGROUND OF THE INVENTION

Automobile accelerator pedals have conventionally been linked to engine fuel subsystems by a cable, generally referred to as a Bowden cable. While accelerator pedal designs vary, the typical return spring and cable friction together create a common and accepted tactile response for automobile drivers. For example, friction between the Bowden cable and its protective sheath otherwise reduce the foot pressure required from the driver to hold a given throttle position. Likewise, friction prevents road bumps felt by the driver from immediately affecting throttle position.

Efforts are underway to replace the mechanical cable-driven throttle systems with a more fully electronic, sensor-driven approach. With the fully electronic approach, the position of the accelerator pedal is read with a position sensor and a corresponding position signal is made available for throttle control. A sensor-based approach is especially compatible with electronic control systems in which accelerator pedal position is one of several variables used for engine control.

Although such drive-by-wire configurations are technically practical, drivers generally prefer the feel, i.e., the tactile response, of conventional cable-driven throttle systems. Designers have therefore attempted to address this preference with mechanisms for emulating the tactile response of cable-driven accelerator pedals. For example, U.S. Pat. No. 6,360,631 to Wortmann et al. is directed to an accelerator pedal with a plunger subassembly for providing a hysteresis effect.

In this regard, prior art systems are either too costly or inadequately emulate the tactile response of conventional accelerator pedals. Thus, there continues to be a need for a cost-effective, electronic accelerator pedal assembly having the feel of cable-based systems.

### SUMMARY

In one embodiment, the present invention is directed to a pedal assembly comprising a pedal housing, a pedal arm rotatably coupled to the pedal housing, a sensor responsive to movement of the pedal arm for providing an electrical signal that is representative of a position of the pedal arm, and a friction generating assembly associated with the housing.

The friction generating assembly includes a brake housing defining at least one braking surface and a brake pad associated with the brake housing and defining at least one contact surface. The brake pad is operable for movement in response to movement of the pedal arm and the contact surface is adapted for engagement with the braking surface for generating friction. The friction generating assembly further comprises at least one spring in the brake housing and an actuator located between the pedal arm and the brake pad and adapted to press against the brake pad when the pedal arm is depressed.

In one embodiment, the pedal housing defines a cavity and the brake housing is a separate cartridge or module adapted to be mounted in the cavity. The cartridge or module has at least the actuator, brake pad, and the spring mounted therein. The pedal arm is adapted to engage the actuator, the actuator is adapted to engage the brake pad, and the brake pad is adapted to engage the spring and the braking surface of the brake housing.

In one embodiment, the cartridge or module defines a central inner wall including respective opposed sides defining respective opposed braking surfaces, the brake pad includes respective arms defining respective contact surfaces and the arms are adapted to be flexed inwardly by the actuator into contact with the opposed braking surfaces of the central wall of the cartridge for generating friction.

In another embodiment, the cartridge or module defines a peripheral interior wall, the brake pad includes respective arms defining respective contact surfaces and the arms are adapted to be flexed outwardly by the actuator into contact with the peripheral interior wall of the cartridge for generating friction.

In all embodiments, a magnet is coupled to the pedal arm and the sensor is coupled to the pedal housing and positioned in proximity to the magnet.

These and other objects, features and advantages will become more apparent in light of the text, drawings and claims.

### BRIEF DESCRIPTION OF THE DRAWINGS

These and other features of the invention can best be understood by the following description of the accompanying drawings as follows:

FIG. 1 is an overall perspective assembled view of an accelerator pedal assembly in accordance with the present invention;

FIG. 2 is a right side exploded perspective view of the accelerator pedal assembly of FIG. 1;

FIG. 3 is a left side exploded perspective view of the accelerator pedal assembly of FIG. 1;

FIG. 4 is a side cross-sectional view of the accelerator pedal assembly of FIG. 1;

FIG. 5 is a broken bottom side pespective view of the accelerator pedal assembly of FIG. 1 with the friction generating assembly exploded therefrom;

FIG. 6 is a broken bottom side pespective view of the accelerator pedal assembly of FIG. 1 with the friction generating assembly mounted therein;

FIG. 7 is an overall enlarged perspective view of the friction generating assembly of the pedal assembly of FIG. 1;

FIG. 8 is an exploded perspective view of the friction generating assembly of FIG. 7;

FIG. 9 is a top horizontal cross-sectional view of of the friction generating assembly of FIG. 7;

FIG. 10 is an exploded perspective view of the magnet assembly of the pedal assembly of FIG. 1;

FIG. 11 is a graph of pedal force versus pedal travel distance for the accelerator pedal assembly of FIG. 1;

FIG. 12 is an overall enlarged pespective view of an alternative embodiment of a friction generating assembly in accordance with the present invention;

FIG. 13 is an exploded perspective view of the friction generating assembly of FIG. 12;

FIG. 14 is a top horizontal cross-sectional view of the friction generating assembly of FIG. 12;

FIG. 15 is an overall enlarged pespective view of an additional embodiment of a friction generating assembly in accordance with the present invention;

FIG. 16 is an exploded perspective view of the friction generating assembly of FIG. 15; and

FIG. 17 is a top horizontal cross-sectional view of the friction generating assembly of FIG. 15.

### DETAILED DESCRIPTION

While this invention is susceptible to embodiment in many different forms, this specification and the accompanying drawings disclose several forms as examples of the invention. The invention is not intended to be limited to the embodiments so described, however. The scope of the invention is identified in the appended claims.

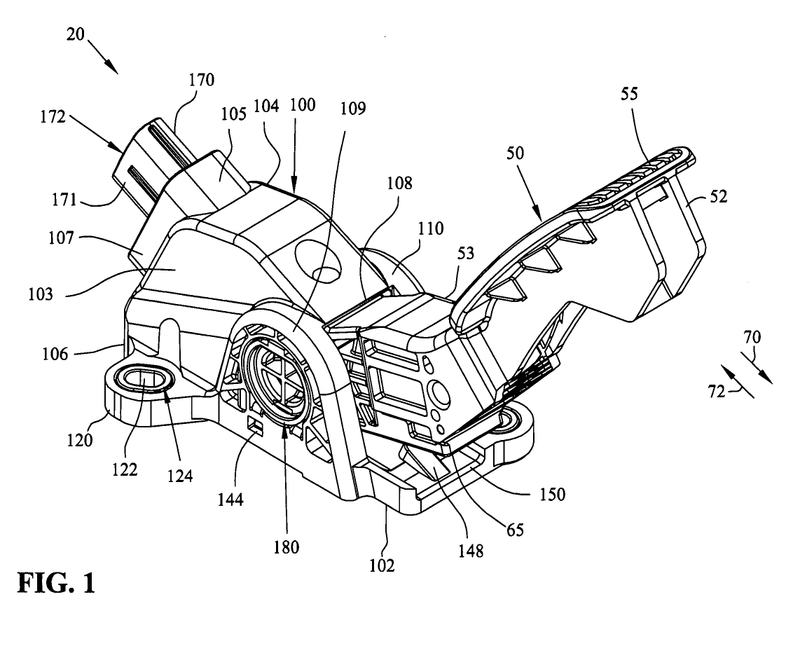

A non-contacting accelerator pedal assembly 20 according to the present invention is shown in FIGS. 1-6. Pedal assembly 20 includes a pedal housing 100 and a pedal arm 50 that is rotatably mounted to the pedal housing 100. Housing 100 contains the components of the pedal assembly and is adapted for mounting to the firewall or floor of a vehicle (not shown). Housing 100 can be formed from molded plastic.

### Pedal Housing

Pedal housing 100 has a bottom wall 102, side walls 103 and 104, top wall 105, and a front wall 106. Side walls 103 and 104 are generally parallel and opposed and are oriented perpendicular to bottom wall 102 and top wall 105. Several openings and cavities are defined in housing 100.

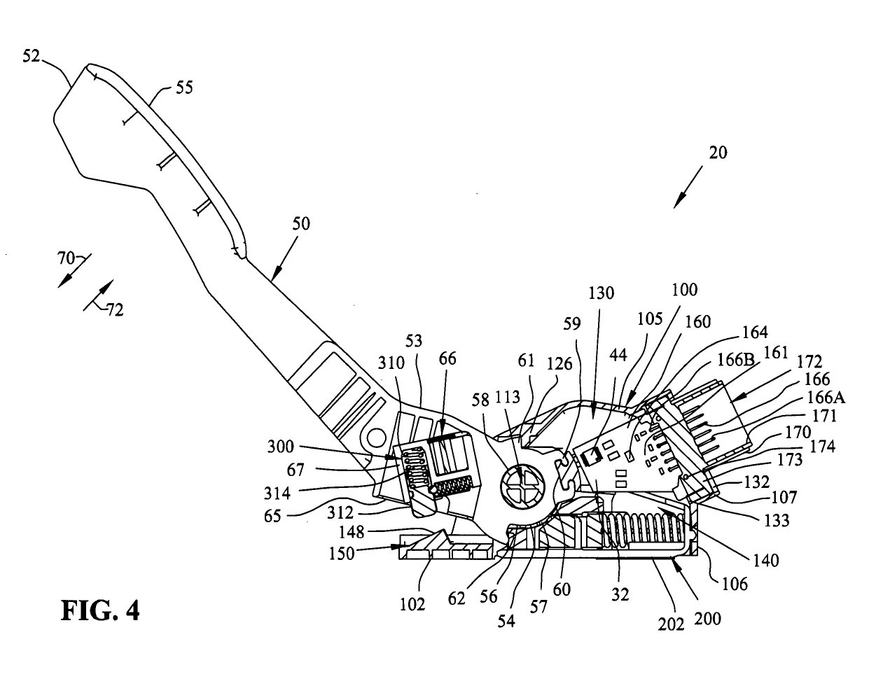

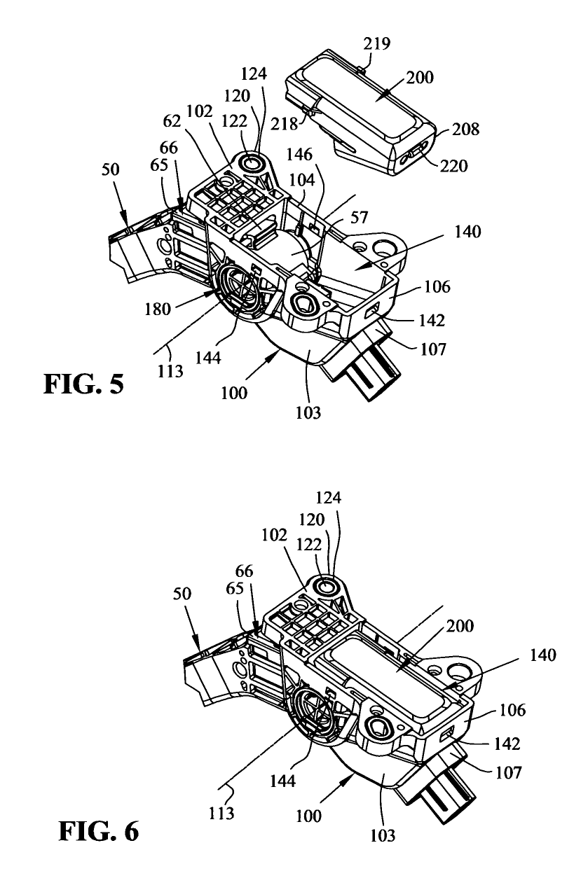

Pedal housing 100 defines a sensor cavity 130 (FIG. 4) and a friction generating assembly cavity 140 (FIG. 5). Sensor cavity 130 is defined within side walls 103 and 104 and top wall 105. Friction generating assembly cavity 140 is defined within bottom wall 102, side walls 103 and 104, and front wall 106. A sensor is adapted to be mounted in sensor cavity 130. A friction generating assembly is adapted to be mounted in friction generating assembly cavity 140.

Pedal housing 100 further defines a pedal arm opening 108 between side walls 103 and 104, bottom wall 102 and top wall 105. Pedal arm 50 extends into pedal arm opening 108.

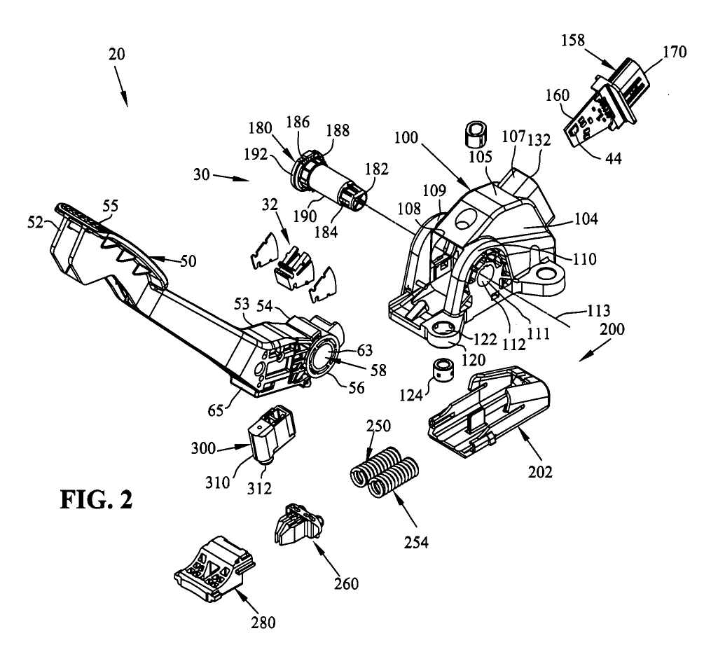

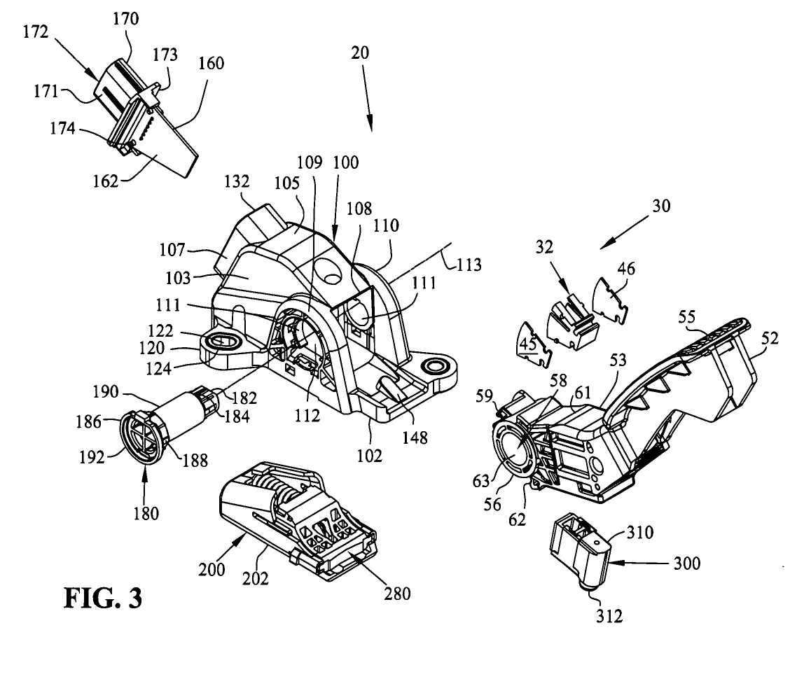

A pair of arc- or curved-shaped shoulders 109 and 110 extend outwardly from side walls 103 and 104 respectively. The ends of the arc shaped shoulders merge into bottom wall 102. A shaft bore 112 (FIGS. 2 and 3) is defined in, and extends through, housing 110 in a relationship that is perpendicular to walls 103 and 104 and is co-linear with an axis of rotation 113. Bore walls 111 (FIGS. 2 and 3) are defined in bearing shoulders 109 and 110 surrounding shaft bore 112.

Three protrusions or anchors 120 extend outwardly from bottom wall 102 and are perpendicular to walls 103 and 104. Each protrusion 120 defines an aperture 122. A metal insert 124 is press fit into aperture 122.

Housing 100 is securable to a vehicle using fasteners such as bolts or screws (not shown) that pass through apertures 122 and are tightened. Pedal assemblies according to the present invention can mount to a firewall or pedal rack by means of an adjustable or non-adjustable position pedal box rack with minor changes to the housing design.

A housing portion 107 (FIGS. 2 and 3) extends outwardly between top wall 105 and front wall 106. Portion 107 defines an opening 132 (FIG. 4) that is contiguous with sensor cavity 130. An annular step 133 (FIG. 4) is located inside portion 107 facing opening 132.

An aperture 142 (FIG. 5) is defined and located in front wall 106. An aperture 144 (FIG. 5) is defined and located in side wall 103 and aperture 146 (FIG. 5) is defined and located in side wall 104. Apertures 142, 144 and 146 are contiguous with friction assembly cavity 140.

A wedge-shaped protrusion 148 (FIGS. 1 and 3) extends upwardly from bottom wall 102 into pedal arm opening 108.

### Pedal Arm

An elongated pedal or pedal arm 50 has a proxil end 54 extending from pedal arm opening 108, and a distal end 52. Center portion 53 is located between ends 52 and 54. Center portion 53 has a bottom side 65. A footpad 55 is located toward distal end 52. Footpad 55 is adapted to be depressed by the foot of a vehicle driver. Footpad 55 may be integral with the pedal arm 50 or may be articulating and rotating at its connection to end 52. Pedal arm 50 can be made from various suitable materials such as injection molded plastics.

Proxil end 54 terminates in a rounded drum 56 that presents a curved, convex surface 57 (best seen in FIG. 5). A bore 58 (FIGS. 3 and 4) is defined in and extends through drum 56. Bore 58 is defined by a circular bore wall 63. When pedal arm 50 is mounted in housing 100, bore 58 is contiguous with bore 112 and coaxial with axis of rotation 113.

A shoulder or stop 61 extends from an upper portion of drum 56 and a rounded cam lobe 62 extends from a bottom portion of drum 56. Cam lobe 62 is located between drum 56 and a bottom side 65.

Pedal arm 50 is retained to, and pivots about, pedal housing 100 via an axle or shaft connection 180 (FIGS. 2 and 3) that passes through drum 56. Axle or shaft 180 is cylindrical in shape and defines smaller and larger ends 182 and 186 respectively. Several ribs 184 are circumferentially located around end 182 and several ribs 188 are circumferentially located around end 186. A round bearing surface 190 is located on axle 180 centered between ends 182 and 186. Flange 192 is formed on end 186.

Axle or shaft 180 passes through bores 58 and 112. End 182 is press fit into bore wall 111 such that ribs 184 are compressed against bore wall 111 in wall 104. Similarly, end 186 is press fit into bore wall 111 on wall 103 such that ribs 186 are compressed against bore wall 111. The compression of ribs 184 and 186 against bore wall 111 affixes axle 180 to the housing 100.

When pedal arm 50 rotates, bore wall 63 pivots on or against bearing surface 190. In other words, bearing surface 190 is stationary while bore wall 63 moves. Pedal arm 50 can be rotated about axis or rotation 113.

### Sensor

A sensor 30 (FIGS. 2 and 3) is mounted to pedal assembly 20 and is adapted to generate an electrical signal that can represent or transmit the position of pedal arm 50. Sensor 30 is comprised of a bipolar tapered magnet assembly or magnet 32 that is attached to pedal arm 50 and a magnetic field sensor 44 that is coupled to the housing 100.

Pedal arm 50 further has a pair of arms or hooks 59 (best viewed in FIG. 4) that form a C-shape and extend outwardly from drum 56. Recess 60 is defined between arms 59.

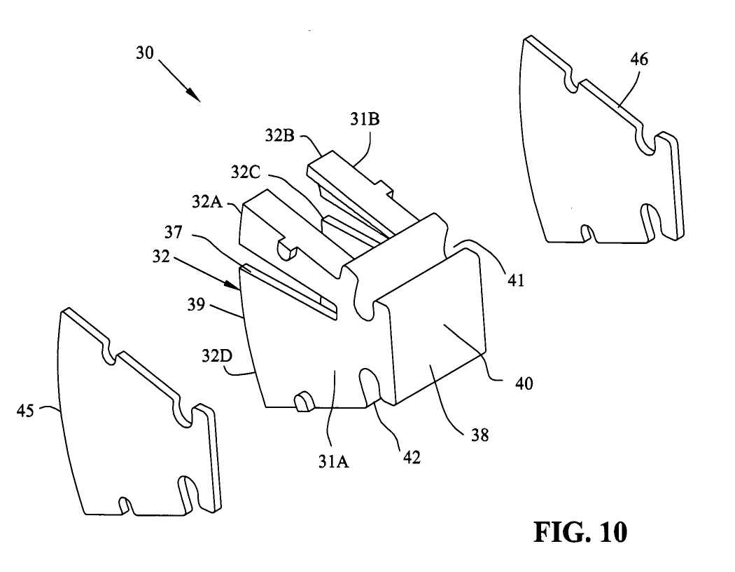

FIG. 10 depicts magnet assembly 32 which has parallel opposed fan-shaped magnet sections 31A and 31B, and a mushroom shaped stem portion 40 that is held to pedal arm 50 by arms 59. Magnet portion 40 has recesses 41 and 42 that extend transversely across magnet assembly 32. Magnet assembly 32 is slid onto arms 59 and into recess 60. Following assembly, arms 59 extend into and are retained in recesses 41 and 42, and stem portion 40 is retained in recess 60.

Sensor 30 includes a bi-polar tapered magnet assembly 32 and a pair of magnetic flux conductors or pole pieces 45 and 46 that are preferably made of steel and mounted on each side of magnet 32. Flux conductor 45 is mounted to magnet section 31A and flux conductor 46 is mounted to magnet section 31B.

Magnet assembly 32 has four alternating (or staggered) magnetic poles: north, south, north, south, collectively labeled with reference numbers 32A, 32B, 32C and 32D. Each pole 32A, 32B, 32C and 32D is integrally formed with stem portion 40 and separated by air gaps 37.

Magnetic poles 32A, 32B, 32C and 32D are sloped such that a diamond shaped air gap 37 is formed between the magnet portions. The sloped magnet poles create a variable flux density magnetic field in the air gap. Magnet assembly 32 can be formed from molded ferrite. Further details of the use and construction of magnet assembly 32 can be found in U.S. Pat. No. 6,211,668, entitled, “Magnetic Position Sensor Having Opposed Tapered Magnets”, the contents of which are herein incorporated by reference in their entirety.

In magnet assembly 32, magnetic flux flows between opposed poles. A zero gauss point is located at about air gap 37. Flux conductors 45 and 46 are on the outsides of the magnet 32 and act both as structural and mechanical supports to magnet 32 and functionally act as electromagnetic boundaries to the flux emitted by the magnet. Magnetic flux conductors 45 and 46 provide a low impedance path for magnetic flux to pass from one pole (e.g., 82A) of the magnet assembly 32 to another of the poles (e.g., 82B).

Magnet assembly 32 creates a variable magnetic field that is detected by a magnetic field sensor 44 (FIGS. 2 and 4) such as, for example, a Hall effect sensor. Acting together, magnet assembly 32 and sensor 44 provide an electrical signal that is representative of the pedal displacement. In one embodiment, magnetic field sensor 44 may be a single Hall effect component or device.

In another embodiment, magnetic field sensor 44 may be a Tri-Axis Integrated Circuit that is commercially available as model number MLX90316 integrated circuit from Melexis Corporation of leper, Belgium. The MLX90316 integrated circuit can measure the magnetic field in two directions or vectors parallel to the integrated circuit surface. The MLX90316 integrated circuit can include one or more internal Hall Effect devices.

FIGS. 2, 3 and 4 depict a magnetic field sensor or Hall effect sensor 44 which is coupled with housing 100 to interact with magnet 32. Magnetic field sensor 44 is mounted in proximity to magnet assembly 32. More specifically, Hall effect sensor 44 is mounted in air gap 37.

Hall effect sensor 44 is responsive to flux changes induced by pedal arm displacement and corresponding motion of magnet assembly 32. Electrical signals from sensor 44 have the effect of converting displacement of the pedal arm 50, as indicated by displacement of the magnet assembly 32, into a dictated speed/acceleration command which is communicated to an electronic control module such as is shown and described in U.S. Pat. Nos. 5,524,589 to Kikkawa et al. and 6,073,610 to Matsumoto et al. hereby incorporated expressly by reference.

Hall effect sensor 44 is mounted to a printed circuit board 160 (FIGS. 2, 3, 4). Printed circuit board 160 is planar in shape and includes opposed sides 161 and 162. Hall effect sensor 44 is adapted for mounting, as by soldering or the like, to side 161. Hall effect sensor 44 is responsive to magnetic flux changes induced by pedal arm displacement and corresponding rotation of drum 56 and magnet assembly 32. More specifically, Hall effect sensor 44 measures magnet flux generated between poles 32A, 32B, 32C and 32D.

Other electronic components 164 such as amplifiers and filters can also be mounted to side 161 to provide signal processing of signals generated by Hall effect sensor 44.

Hall effect sensor 44 is operably connected through circuit board 160 to terminals 166 (FIG. 4). Terminals 166 are soldered to printed circuit board 160. Terminals 166 define respective ends 166A and 166B. Ends 166B are soldered to printed circuit board 160 and ends 166A extend into connector cavity 172. Terminal ends 166a may mate with an external wiring harness that can be connected to an engine controller or computer in a vehicle.

A connector assembly 158 (FIG. 2) is adapted for attachment to housing 100. Connector assembly 158 includes a rectangular shaped wall 171 (FIG. 3) that defines a cavity 172. Terminal ends 166A extend into cavity 172. Wall 171 terminates in an annular flange 173 that surrounds and extends outwardly from wall 171. Flange 173 can be ultrasonically welded to housing portion 107 to retain the connector to the housing.

Fasteners 174, such as screws or bolts, are adapted to attach printed circuit board 160 to flange 173. Flange 173 is mounted in opening 132 such that flange 173 rests against step 133 and printed circuit board 160 extends into sensor cavity 130.

Drum 56 has an outwardly extending shoulder or stop 61 (FIG. 4). Pedal arm 50 has predetermined rotational limits in the form of an idle, return or rest position stop 61. When pedal arm 50 is released, pedal arm 50 will rotate until stop 61 contacts ridge or lip 128 thereby limiting backward movement of the pedal arm 50.

Pedal arm 50 can be depressed until it reaches another rotational limit at an open-throttle position where bottom side 65 of pedal arm 50 contacts portion 150 of bottom wall 102 thereby limiting forward movement of pedal arm 50.

A cavity 66 (best viewed in FIG. 4) is located in center portion 53 of pedal arm 50 and is open toward bottom side 65. Cavity 66 is defined by walls 67. A kickdown device 300 is adapted to be mounted in cavity 66.

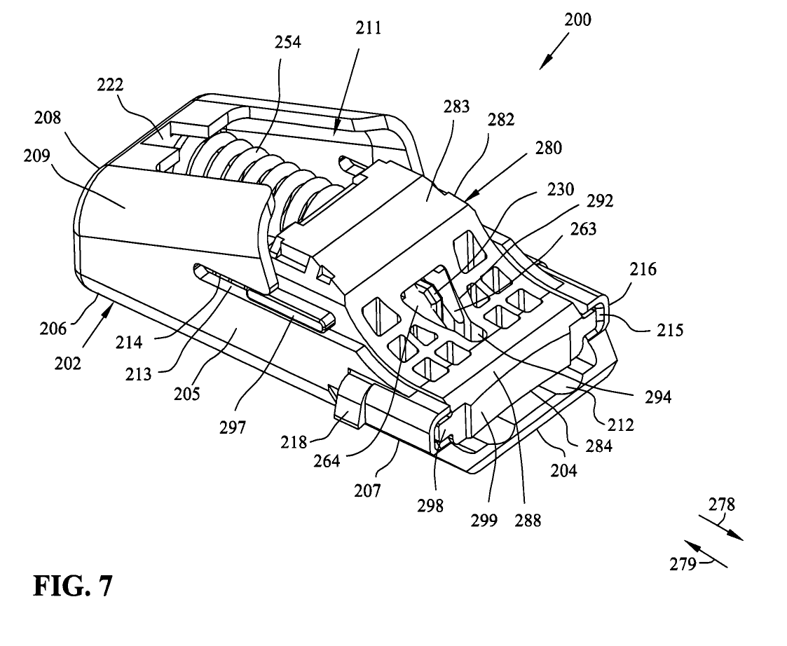

Kickdown device 300 includes a button 310, a housing 312, and a spring 314 located within housing 312. Kickdown device 300 is adapted to be mounted to pedal arm 50. Housing 312 is press-fit into cavity 66 and firmly in contact with walls 67 of pedal arm 50. Kickdown device 300 provides an increased resistance to pedal depression at a certain point in the depression of pedal arm 50. Details of the use and construction of kickdown device 300 can be found in U.S. Pat. No. 6,418,813, entitled, “Kickdown Mechanism for a Pedal”, the contents of which are herein incorporated by reference in entirety. Friction Generating Assembly Friction generating assembly 200 is shown in FIGS. 7-9 and is adapted for mounting in friction generating assembly cavity 140 (FIG. 5). In the embodiment shown, friction generating assembly 200 includes a separate brake housing or cartridge or module 202 having at least the following elements mounted therein: springs 250 and 254, brake pad 260, and actuator 280.

Brake housing 202 is generally rectangular in shape and has a bottom wall 204 that curves and is contiguous with parallel opposed side walls 205. Brake housing 202 defines opposed ends 206 and 207. End wall 208 is located at end 206 and is perpendicular to bottom wall 204. Upper walls 209 extend upwardly and curve inwardly from a portion of side walls 205 and join with end wall 208. Upper walls 209 are angled upwardly from side walls 205. Upper walls 209 are about half the length of side walls 205.

Brake housing 202 may be formed from any suitable material such as injection molded plastic and, more specifically, from a plastic having a high yield strength.

Walls 204, 205, 208 and 209 define a cavity 210. An opening 211 is defined between walls 209 and end wall 208. A pair of elongated channels or grooves 212 extend along the length of bottom wall facing cavity 21. A slot 214 is located in each of side walls 205. Slots 214 are parallel and opposed and are separated by cavity 210 and extend about half the length of side walls 205. Walls 205 define a top edge 213 that extends into slot 214.

Brake housing 202 further has a pair of generally C-shaped portions 216 that define slots or grooves 215. Portions 216 extend from side walls 205 toward end 207, are separated by cavity 210, and are parallel and opposed. A pair of locking tabs or fingers 218 and 219 extend outwardly from each of portions 216 and another locking tab or finger 220 (FIG. 5) extends outwardly from end wall 208.

A slot 222 is defined between upper walls 209. Slot 222 is contiguous with opening 211 and terminates at end wall 208. A pair of conical shaped bosses 224 extend from end wall 208 toward cavity 210.

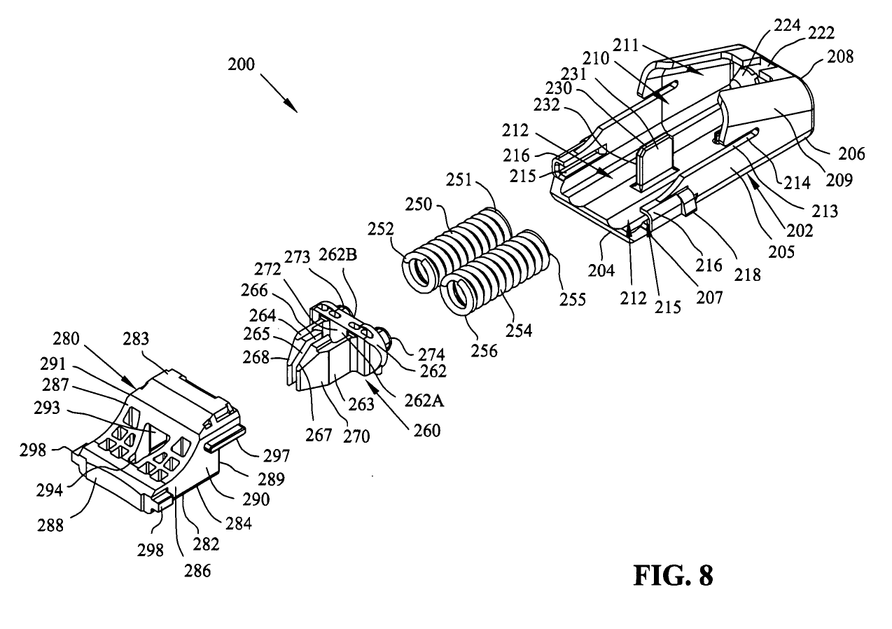

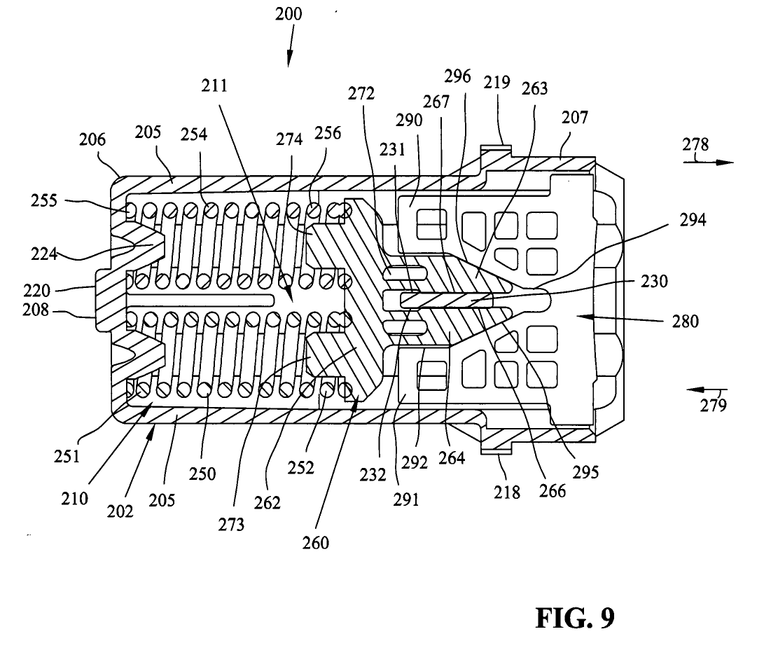

A rib or brake wall 230 (FIGS. 8 and 9) extends upwardly from bottom wall 204. Brake wall 230 is located substantially near the center of brake housing 202 and extends generally parallel with the length of housing 202 and is oriented perpendicular to bottom wall 204.

Wall 230 has two opposed surfaces. Brake surface 231 is located on one side of wall 230 and brake surface 232 is located on the other side of wall 230. Brake surfaces 231 and 232 may be of the same material as wall 230 or brake surfaces 231 and 232 may be formed of a material that has an increased coefficient of friction.

With continued reference to FIGS. 7, 8 and 9, friction generating assembly 200 further includes a brake pad 260 that is configured to be engaged with wall 230 and braking surfaces 231 and 232. Brake pad 260 has a central body 262 with sides 262A and 262B. A pair of elongated parallel arms 263 and 264 extend outwardly perpendicularly from side 262A. Arms 263 and 264 define respective outer surfaces which, in combination, form a V whose legs diverge outwardly from each other in the direction of springs 250 and 254. Arms 263 and 264 are separated by a slot 265. Arm 263 has an inward facing contact surface 267 and an outward facing angled surface 270. Arm 264 has an inward facing contact surface 266 and an outward facing angled surface 268. Contact surfaces 266 and 267 are juxtaposed and face each other across slot 265 prior to being assembled in brake housing 202. After brake pad 260 is mounted in brake housing 202, contact surface 266 is adjacent to and adapted for engagement with braking surface 232 while contact surface 267 is adjacent to and adapted for engagement with braking surface 231.

An opening 272 is defined between arms 263 and 264 adjacent body 262 where arms 263 and 264 meet body 262. Opening 272 is contiguous with slot 265. A pair of barrel shaped bosses or projections 273 and 274 extend outwardly perpendicularly from side 262B in a direction that is opposite the direction of arms 263 and 264.

Brake pad 260 can be formed from any suitable material that can provide a desired coefficient of friction for contact surfaces 266 and 267.

A pair of coil springs 250 and 254 are mounted inside cavity 210. Springs 250 and 254 rest in separate channels 212. Spring 250 defines opposed ends 251 and 252. Spring 254 defines opposed ends 255 and 256. Springs 250 and 254 are compressed between end wall 208 and brake pad 260. Springs 250 and 254 bias pedal arm 50 outwardly to a rest or idle position. Spring ends 251 and 255 are retained in housing 200 by mounting over bosses 224. Bosses 224 extend partially into springs 250 and 254. Spring ends 252 and 256 are retained by brake pad 260 by mounting over bosses or projections 273 and 274. Projections 573 and 574 extend partially into springs 250 and 254.

Two springs are used for redundancy reasons. If one spring were to fail, another would still be operational. This redundancy is provided for improved reliability, allowing one spring to fail or fatigue without disrupting the biasing function. It is useful to have redundant springs and for each spring to be capable on its own of returning the pedal arm to its idle position. Other types of springs could also be used such as, for example, leaf springs or torsion springs.

Brake pad 660 further has a projection or post 710 that extends perpendicularly from central body 662 parallel to arms 663 and 664. Post 710 extends partially over gap 665. Post 710 is located between arms 663 and 664 and is slightly shorter than arms 663 and 664. A pair of slots 712 separate the post 710 from arms 663 and 664. Slots 712 extend parallel to arms 663 and 664. After actuator 680 is mated with brake pad 660, post 710 extends over a portion of actuator top surface 683 toward the back 689. Post 710 assists in keeping actuator 680 in alignment with brake pad 660 and preventing actuator 680 from pivoting upwardly when forces are applied to actuator 680. Post 710 also prevents wear from occurring on top wall 609 as actuator 680 moves.

With continued reference to FIGS. 7, 8 and 9, actuator 280 is mounted in cavity 210 adjacent to and in contact with brake pad 260. Actuator 280 has a central body 282. Body 282 has a top 283, bottom 284, side 286, side 287, front 288, and back 289.

A pair of arms 290 and 291 extend downwardly from top 283 toward back 289. A V-shaped recess 292 is defined between arms 290 and 291. A triangularly-shaped opening 293 extends through top 283 into recess 292. Opening 293 is contiguous with recess 292. A slot 294 is defined in body 282 at one end of recess 292.

Arm 290 has a wedging surface 296 and arm 291 has a wedging surface 295 (FIG. 9). Wedging surface 295 is adjacent to and contacts angled surface 268 and wedging surface 296 is adjacent to and contacts angled surface 270. Wedging surfaces 295 and 296 are diametrically opposed and diverge outwardly from each other in the direction of springs 250 and 254.

A pair of elongated rectangularly-shaped guide rails 297 extend outwardly from a portion of sides 286 and 287. Guide rails 297 are located toward back 289. Rails 297 rest on top edge 213 and mate with slots 214 of housing 202. Rails 297 slide on edge 213 and within slot 214 as actuator 280 is moved.

A pair of elongated rectangularly-shaped guide rails 298 (FIG. 8) extend outwardly from a portion of sides 286 and 287. Rails 298 are located toward front 288. Rails 298 are mounted for sliding movement within channels 215 of housing 202. Rails 298 slide within channel 215 as actuator 280 is moved.

Rails 297 and 298 retain actuator 280 to housing 202 and guide movement of actuator 280 in a linear manner in directions 278 and 279. Actuator 280 can be moved further into housing 202 in direction 279 and can be moved further out of housing 202 in direction 278.

An elongated planar camming surface 299 (FIG. 7) extends along front 288 of actuator 280 and is adapted to be engaged by cam lobe 62 (FIG. 4) after assembly 500 is mounted to housing 100 (FIG. 4).

In the disclosed embodiment, friction generating assembly 200 is designed to be mounted or snapped in friction generating assembly cavity 140 (FIG. 5) as a single, separate module or modular unit. FIG. 5 shows friction generating assembly 200 prior to insertion in friction generating assembly cavity 140 of housing 100. Friction generating assembly 200 is placed in friction generating cavity 140 and housing 202 is pressed downwardly such that locking tabs 218 and 219 slide against side walls 103 and 104 and locking tab 220 slides against front wall 106. As housing 202 is pressed further into friction generating cavity 140, it reaches a stop position where locking tab 218 snaps into aperture 144, locking tab 219 snaps into aperture 146 and locking tab 220 snaps into aperture 142. Friction generating assembly 200 is then securely retained to housing 100 in friction generating assembly cavity 140.

The use of friction generating assembly 200 has many advantages. Because friction generating assembly 200 is a modular self-contained, separate friction generating unit, it can be used with a wide variety of housing and pedal arm shapes and sizes. For example, different vehicles may require slightly different housing and pedal arm designs due to the configuration of vehicle floors, vehicle firewalls, mounting holes, pedal locations, and connector mounting locations.

Because friction generating assembly 200 is a modular self contained friction generating unit, the design of friction generating assembly 200 can remain constant while the shape and size of housing 100 and pedal arm 50 is customized for each vehicle application as necessary. Operation Turning now to FIGS. 4 and 9, pedal arm 50 can be depressed by a user and move in a first direction 70 (accelerate) or pedal arm 50 can be released and move in the other direction 72 (decelerate). As pedal arm 50 is depressed and moves in direction 70, pedal arm 50 rotates downwardly and forces cam lobe 62 to be engaged with or press on camming surface 299. Cam lobe 62 and camming surface 229 translate the rotary motion of pedal arm 50 into linear motion of actuator 280. As pedal arm 50 is depressed further, actuator 280 is moved in direction 279 (i.e., toward springs 250 and 254) forcing actuator wedge surfaces 295 and 296 into contact with brake pad angled surfaces 268 and 270 and, by virtue of the respective V-shapes defined by the actuator 230 and arms 263 and 264, forcing brake pad arms 263 and 264 to bend and be moved inwardly toward each other. Recess 292 is forced onto or wedged onto arms 263 and 264 of brake pad 260.

The inward motion of arms 263 and 264 forces brake pad contact surfaces 266 and 267 into further engagement with braking surfaces 231 and 232 of wall 230, thereby increasing the normal forces, contact forces, or frictional forces between brake pad contact surfaces 266, 267 and wall braking surfaces 231, 232. As actuator 280 is moved further in direction 279, the frictional force generated between brake pad contact surfaces 266 and 267 and wall braking surfaces 231 and 232 increases. Moreover, as actuator 280 moves further into housing 202, the force required to move actuator 280 increases.

The resulting drag between brake pad surfaces 266 and 267 and wall braking surfaces 231 and 232 resists the movement of pedal arm 50 in direction 70 and can be felt by the person or user depressing pedal arm 50 with their foot.

At the same time that pedal arm 50 is moved in first direction 70 (accelerate), the spring force Fs within compression springs 250 and 254 increases as springs 250 and 254 are compressed between brake pad 260 and housing 202. The increased force Fs urges brake pad 260 toward or into actuator 280. More specifically, brake pad arms 263 and 264 are wedged into recess 292.

The effect of the depression of the pedal arm 50 leads to an increasing normal force exerted by the brake pad contact surfaces 266 and 267 against braking surfaces 231 and 232. A friction force between the brake pad contact surfaces 266 and 267 and wall braking surfaces 231 and 232 is defined by the coefficient of dynamic friction multiplied by the normal force. As the normal force increases with increasing applied force at the pedal arm, the friction force accordingly increases. The driver feels this increase in his/her foot at pedal arm 50. The friction force opposes the applied force as the pedal is depressed and subtracts from the spring force as the pedal is being returned toward the idle position.

Movement of actuator 280 within housing 202 is guided by rails 297 engaged with slots 214 and rails 298 engaged with channels 215.

When force on pedal arm 50 is reduced, or pedal arm 50 is released and moves in direction 72, the opposite effect is present. Pedal arm 50 rotates upwardly and springs 250 and 254 decompress to urge brake pad 260 to move actuator 280 in direction 278 (i.e., away from springs 250 and 254) outwardly from housing 202. Springs 250 and 254 return pedal arm 50 to a rest or idle position.

As actuator 280 moves in direction 278, the frictional or drag forces between contact surfaces 266 and 267 on arms 264 and 263 respectively and braking surfaces 231 and 232 on wall 230 are reduced. As actuator 280 moves in direction 278, arms 263 and 264 decrease the pressure applied to wall 230. While the pressure on wall 230 is decreased, it does not drop to zero such that some drag or friction occurs between contact surfaces 266 and 267 and braking surfaces 231 and 232 as pedal 50 moves.

As brake pad 260 and actuator 280 move in direction 278, a slight wedging effect will still occur between V-shaped portions of brake pad 260 and actuator 280. More specifically, angled surfaces 268 and 270 (FIG. 8) of brake pad 260 are pressed into contact with V-shaped wedge surfaces 295 and 296 of actuator 280 forcing arms 263 and 264 to bend and be moved inwardly toward each other. In this manner, a low amount of drag force is generated between contact surfaces 266 and 267 and braking surfaces 231 and 232 respectively as actuator 280 moves in direction 278.

The resulting drag between contact surfaces 266 and 267 and braking surfaces 231 and 232 slows the movement in direction 72 and can be felt by the person touching pedal arm 50. Further reduction in force on pedal arm 50 results in pedal arm 50 moving to an idle engine position.

The sliding motion of actuator 280 into brake pad 260 is gradual and can be described as a “wedging” effect that either increases or decreases the force urging brake pad contact surfaces 266 and 267 into wall braking surfaces 231 and 232. This force is directionally dependent and the force has hysteresis.

The force required to depress the pedal is not equal to the force required to return the pedal. More force is required to depress the pedal due to the friction generated between brake pad contact surfaces 266 and 267 and wall braking surfaces 231 and 232 than is required to extend the pedal. The forces required to extend the pedal are supplied by the decompression of springs 250 and 254. Hysteresis in pedal arm force is desirable in that it approximates the feel of a conventional mechanically-linked accelerator pedal.

The friction force adds to the spring force during depression of the pedal arm and the friction force subtracts from the spring force as the pedal is released or returned toward its idle position.

With reference now to FIGS. 4 and 10, as pedal arm 50 moves in direction 70, magnet assembly 32 also moves due to it being connected to drum 56 of pedal arm 50. Movement of pedal arm 50 causes magnet assembly 32 to move in an arc-shaped path within sensor cavity 130. The movement of magnet assembly 32 is relative to the magnetic field sensor or Hall effect device 44 that is fixed in position to printed circuit board 160. The movement of magnet assembly 32 causes the flux field passing generally normal to Hall effect device 44 to change in magnitude and polarity. This variation in flux magnitude and polarity is sensed by Hall effect device 44. Hall effect device 44 generates an electrical signal that is proportional to the flux magnitude and polarity. The electrical signal is representative of or indicative of the position of pedal arm 50. The electrical signal may be at least partially proportional to either the flux magnitude or the polarity of the flux.

This electrical signal can be amplified and conditioned by signal conditioning electronic components 164 on printed circuit board 160 and then carried on terminals 166 to an external wire harness (not shown). The external wire harness in adapted to be in communication with an engine controller or computer (not shown) on a vehicle. The engine controller can use the electrical signal to control at least one parameter of the operation of the engine.

In one alternative embodiment, magnet assembly 32 (FIGS. 2, 3, 4) may be attached or coupled to actuator 280 instead of drum 56 of pedal arm 50 if desired. When actuator 280 is moved, magnet assembly 32 would also be moved relative to magnetic field sensor 44.

As pedal arm 50 moves further in direction 70, button 312 of kickdown device 300 will eventually contact wedge shaped protrusion 148. Further depression of pedal arm 50 pushes in on button 312 causing compression of a spring 314 within housing 310.

The movement of button 310 is felt by the person depressing pedal arm 50 as a further increase in force or resistance as the pedal is depressed. This is called a “kickdown force” and is typically designed to occur at or indicate a wide open throttle position.

Pedal arm 50 can be further depressed in direction 70 until it reaches a rotational limit at a wide open throttle position where bottom side 65 of pedal arm 50 contacts portion 150 of bottom wall 102 thereby limiting forward movement of pedal arm 50.

It is noted that while a magnet and Hall effect sensor are used in the present embodiment to detect the position of the pedal, other types of sensors could also be used such as linear or rotary resistive position sensors, GMR sensors, capacitive sensors and inductive sensors.

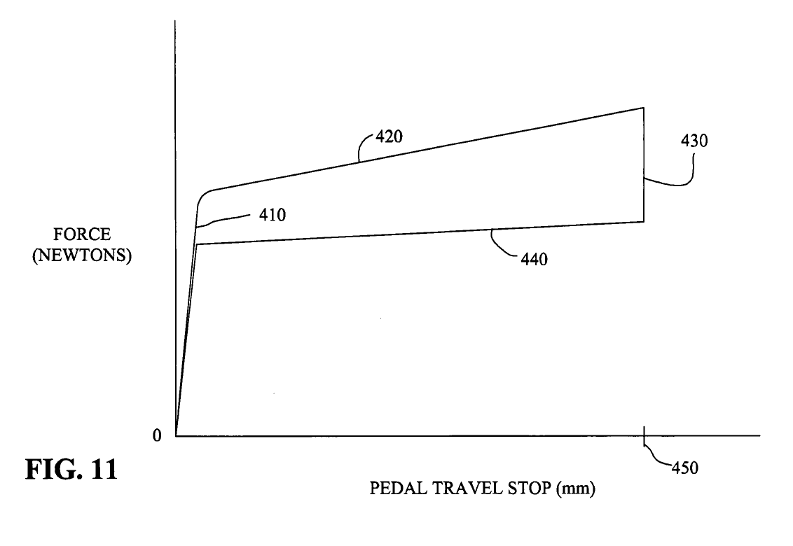

A graph of pedal force versus pedal travel distance for the accelerator pedal assembly 20 is shown in FIG. 11 which, in particular, is a force diagram demonstrating the directionally dependent actuation-force hysteresis provided by accelerator pedal assemblies according to the present invention. The y-axis represents the foot pedal force required to actuate the pedal arm 50 in Newtons (N). The x-axis represents displacement of the footpad 55 of pedal arm 50 in millimeters (mm).

Path 410 represents the pedal force required to begin depressing pedal arm 50 in direction 70. Path 420 represents the relatively smaller increase in pedal force necessary to continue moving pedal arm 50 after initial displacement toward a wide open throttle position and mechanical travel stop 450. Path 430 represents the decrease in foot pedal force allowed before pedal arm 50 begins movement in the opposite direction 72 toward an idle position.

Path 430 corresponds to a no-movement zone that allows the driver to reduce foot pedal force while still holding the same accelerator pedal position. Over path 440, peal arm 50 is in motion as the force level decreases.

FIG. 11 depicts pedal operation according to the present invention over a complete cycle of actuation from a point of zero pedal pressure, i.e., an idle position, to the fully depressed position and then back to idle position again with no pedal pressure. The shape of this operating curve also applies, however, to mid-cycle starts and stops of the accelerator pedal. For example, when the accelerator pedal is depressed to a mid-position, the driver still benefits from a no-movement zone (path 430) when foot pedal force is reduced.

### First Alternative Friction Generating Assembly Embodiment

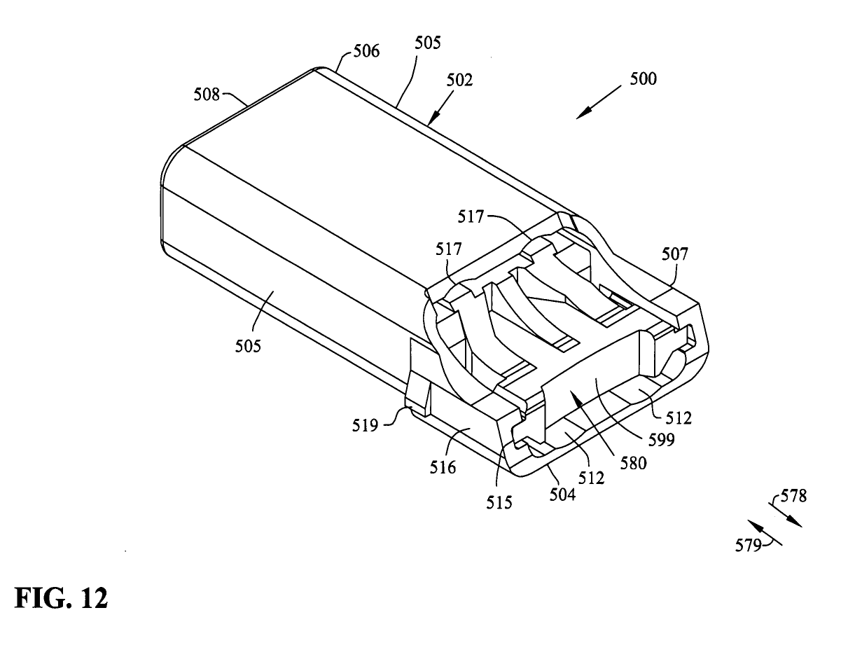

An alternative embodiment of a friction generating assembly or cartridge or module 500 is shown in FIGS. 12-14. Friction generating assembly 500 is adapted to be mounted in friction generating assembly cavity 140 (FIG. 5). Friction generating assembly 500 includes a brake housing or cartridge or module 502 having at least the following elements mounted therein: springs 550 and 554; brake pad 560; and actuator 580.

Friction generating assembly 500 is similar to friction generating assembly 200 except that the braking surfaces are located on the outer side walls of the housing instead of an inner wall as in assembly 200.

Brake housing 502 is generally rectangular in shape and has a bottom wall 504 that adjoins parallel opposed spaced apart side walls 505. A top wall 509 adjoins side walls 505. Top wall 509 is parallel, opposed to, and spaced apart from bottom wall 504. Brake housing 502 defines opposed ends 506 and 507. End wall 508 is located at end 506 and is perpendicular to bottom wall 504 and top wall 509. Top wall 509 is slightly shorter than bottom wall 504.

Brake housing 502 may be formed from any suitable material such as injection molded plastics and, more specifically, from plastics having a high yield strength.

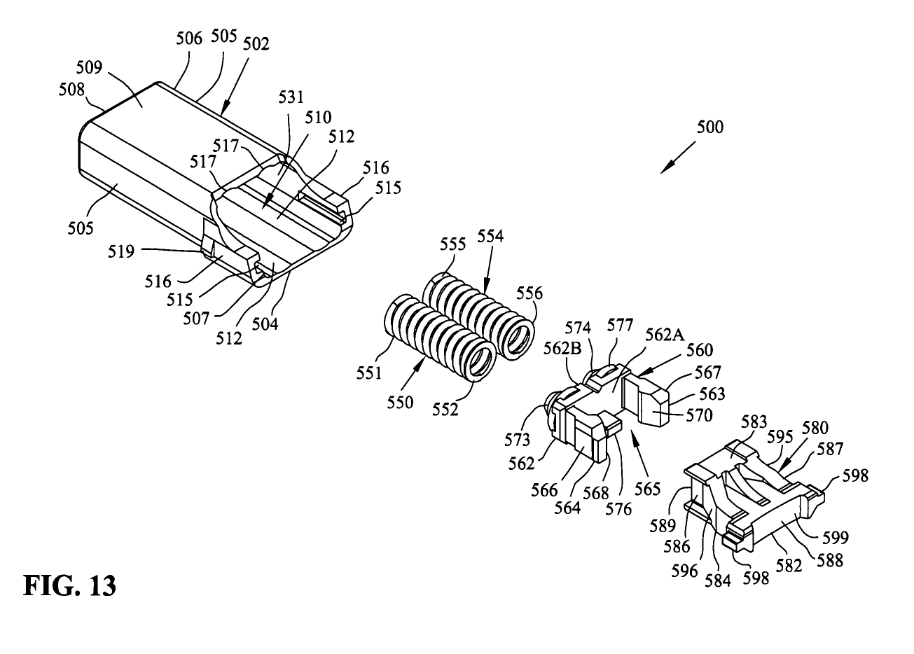

Walls 504, 505, 508 and 509 define an interior chamber or cavity 510. Cavity 510 opens or faces toward end 507. Actuator 580 is located outside the cavity 510. Springs 550 and 554 and brake pad 560 are located inside cavity 510. A pair of shallow, elongated, spaced-apart and parallel channels or grooves 512 extend along the length of bottom wall 504 facing upwardly toward cavity 510. Another pair of shallow elongated channels or grooves 517 extend along the length of top wall 509 facing downwardly toward cavity 510 (FIG. 13).

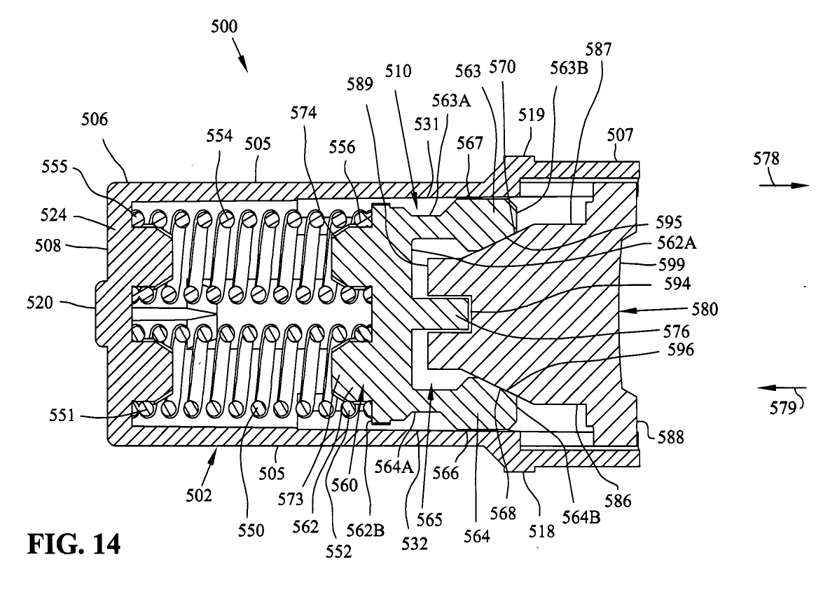

The interior surface of each of the peripheral walls 505 defines braking surfaces 531 and 532 (FIG. 14). Braking surfaces 531 and 532 are parallel and opposed to each other and face cavity 510. Brake surfaces 531 and 532 may be of either the same material as walls 505 or a material having an increased coefficient of friction.

Brake housing 502 further has a pair of generally C-shaped portions 516 that define interior opposed slots or grooves 515. Portions 516 extend from side walls 505 toward end 507, are separated by cavity 510, and are parallel and opposed. A pair of locking tabs or fingers 518 and 519 extend outwardly from each of the portions 516 and another locking tab or finger 520 extends outwardly from end wall 508. A pair of conically-shaped bosses 524 extends from end wall 508 into cavity 510.

With continued reference to FIGS. 12-14, friction generating assembly 500 further includes a brake pad 560 that is configured for engagement with the housing braking surfaces 531 and 532. Brake pad 560 is generally U-shaped and has a central body 562 with opposed surfaces 562A and 562B. A pair of elongated, parallel, spaced-apart arms 563 and 564 extend outwardly perpendicularly from side 562A. Arms 563 and 564 and body 562 in combination define a central gap or slot 565. Arm 563 has a narrow or thin end 563A and a wide or thick end 563B. Diametrically opposed arm 564 has a narrow or thin end 564A and a wide or thick end 564B. Narrow ends 563A and 564A allow arms 563 and 564 to slightly bend or flex when forces normal to the length of arms 563 and 564 are applied. A guide post 576 (FIG. 13) extends perpendicularly centrally outwardly from side 562A in a relationship parallel to and spaced from arms 563 and 564.

Arm 563 has an outward or outer flat contact surface 567 and an inward or inner facing angled surface 570. Arm 564 has an outward or outer facing flat contact surface 566 and an inward or inner facing angled surface 568. Angled surfaces 568 and 570 are juxtaposed and face each other prior to being assembled in brake housing 502. Angled surfaces 568 and 570 diverge outwardly away from each other in the direction of brake housing end 532.

After brake pad 560 is mounted in brake housing 502, brake pad contact surface 566 is adjacent to and adapted for engagement with housing braking surface 532 while brake pad contact surface 567 is adjacent to and can be engaged with wall braking surface 531.

A pair of barrel-shaped bosses or projections 573 and 574 extend outwardly perpendicularly from the surface 562B of brake pad 560 in a direction that is opposite the direction of arms 573 and 574.

Brake pad 560 can be formed from any suitable material adapted to provide a desired coefficient of friction for contact surfaces 566 and 567.

A pair of coil springs 550 and 554 are mounted inside cavity 510. Springs 550 and 554 rest in separate channels 512. Spring 550 defines opposed ends 551 and 552. Spring 554 defines opposed ends 555 and 556. Springs 550 and 554 are compressed between end wall 508 and brake pad 560. Springs 550 and 554 bias pedal arm 50 outwardly to a rest or idle position. Spring ends 551 and 555 are retained in housing 502 by mounting over bosses 524. Bosses 524 extend partially into springs 550 and 554. Spring ends 552 and 556 are retained by brake pad 560 by mounting over bosses or projections 573 and 574. Bosses 573 and 574 extend partially into springs 550 and 554.

A pair of guide ribs 577 extend outwardly from the top side of brake pad body 562 (FIG. 13). After assembly of brake pad 560 in housing 502, guide ribs 577 reside in channels 517 defined in the top wall of housing 502. Guide ribs 577 and channels 517 assist with keeping brake pad 560 tracking in a linear path when brake pad 560 is moved.

Two springs are used for redundancy reasons. If one spring were to fail, another would still be operational. This redundancy is provided for improved reliability, allowing one spring to fail or fatigue without disrupting the biasing function. It is useful to have redundant springs and for each spring to be capable on its own of returning the pedal arm to its idle position. Other types of springs could also be used such as leaf springs or torsion springs.

With continued reference to FIGS. 12-14, actuator 580 is mounted in brake housing 502 adjacent to and in contact with brake pad 560. Actuator 580 defines a central body 582. Body 582 defines a top 583, bottom 584, side 586, side 587, front 588 and back 589.

An angled wedging surface 596 is located on side 586 and an angled wedging surface 595 is located on side 587. Wedging surface 595 is substantially parallel and adjacent to and can be pressed into contact with angled surface 570 of brake pad arm 563. Wedging surface 596 is substantially parallel and adjacent to and can be pressed into contact with angled surface 568 of brake pad arm 564. Wedging surfaces 595 and 596 together converge inwardly in the direction of springs 550 and 554.

A slot 594 (FIG. 14) is located in back 589 and extends partially into body 582 of actuator 580. Brake pad guide post 576 extends into actuator slot 594. Guide post 576 and slot 594 further guide linear movements of actuator 580 and brake pad 560.

A pair of elongated rectangularly-shaped guide rails 598 (FIG. 13) extend outwardly from opposed sides 586 and 587. Rails 598 are located toward front 588. Rails 598 are mounted for sliding movement within channels 515 of housing 502. Rails 598 slide within channel 515 as actuator 580 is moved. Rails 598 retain actuator 580 in housing 502 and guide the movement of actuator 580 in a linear manner as actuator 580 moves in directions 578 and 579. Actuator 580 can be moved further into housing 502 in direction 579 and can be moved further out of housing 502 in direction 578.

An elongated planar camming surface 599 (FIG. 13) extends along the front 588 of actuator 580 and is adapted to be engaged by cam lobe 62 (FIG. 4) of pedal arm 50 after assembly 500 is mounted to housing 100 (FIG. 4).

Friction generating assembly 500 is adapted to be mounted in the friction generating assembly cavity 140 (FIG. 5) defined in the pedal housing as a single, separate module or modular unit and further is adapted to replace friction generating assembly 200. If replaced in the embodiment of FIG. 5, friction generating assembly or cartridge or module 500 would be placed in friction generating cavity 140 and cartridge or module 502 pressed downwardly such that locking tabs 518 and 519 slide against side walls 103 and 104 and locking tab 520 slides against front wall 106. As housing 502 is pressed further into friction generating cavity 140, it reaches a stop position where locking tab 518 snaps into hole 144, locking tab 519 snaps into hole 146 and locking tab 520 snaps into hole 142. Friction generating assembly 500 is then securely retained to housing 100 in friction generating assembly cavity 140.

The use of friction generating assembly 500 has many advantages. Because friction generating assembly 500 is a modular self-contained friction generating unit, it can be used with a wide variety of housing 100 and pedal arm 50 shapes and sizes. For example, different vehicles may require slightly different housing and pedal arm designs due to the configuration of vehicle floors, vehicle firewalls, mounting holes, pedal locations and connector mounting locations.

Because friction generating assembly 500 is a modular self-contained friction generating unit, the design of friction generating assembly 500 can remain constant while the shape and size of housing 100 and pedal arm 50 is customized for each vehicle application as necessary.

Operation with First Alternative Friction Generating Assembly Embodiment

Pedal assembly 20 can be operated using friction generating assembly 500 in a similar manner as previously described for friction generating assembly 200. Friction generating assembly 500 can replace friction generating assembly 200 in FIGS. 4-6. The operation of friction generating assembly 500 will now be explained in conjunction with FIGS. 4-6 assuming that friction generating assembly 500 has replaced friction generating assembly 200 in FIGS. 4-6.

Turning now to FIGS. 4 and 14, pedal arm 50 can be depressed by a user and move in a first direction 70 (accelerate) or pedal arm 50 can be released and move in the other direction 72 (decelerate). As pedal arm 50 is depressed and moves in direction 70, pedal arm 50 rotates downwardly and forces pedal arm cam lobe 62 to be engaged with or press on actuator camming surface 599. Cam lobe 62 and camming surface 599 translate the rotary motion of pedal arm 50 into linear motion of actuator 580. As pedal arm 50 is depressed further, actuator 580 is moved in direction 579 (i.e., in direction of springs 550 and 554) forcing actuator wedge surfaces 595 and 596 into contact with brake pad angled surfaces 568 and 570 and forcing arms 563 and 564 to bend and be moved laterally outwardly in opposite directions away from each other generally perpendicular to the motion of actuator 580. Actuator 580 forces or wedges arms 563 and 564 against the outer peripheral walls 505 of brake housing 502.

The outward motion of arms 563 and 564 forces outside arm contact surfaces 566 and 567 into further engagement with all braking surfaces 531 and 532 and increases the normal contact or frictional forces between arm contact surfaces 566, 567 and housing braking surfaces 531 and 532. The frictional force generated between contact surfaces 566 and 567 and housing braking surfaces 531 and 532 increases as actuator 580 is moved further in direction 579. Moreover, as actuator 580 is moved further, the force required to move actuator 580 increases as actuator 580 is moved further into housing 502.

The resulting drag between arm contact surfaces 566 and 567 and housing braking surfaces 531 and 532 resists the movement of pedal arm 50 in direction 70 and can be felt by the person or user depressing pedal arm 50 with their foot.

At the same time that pedal arm 50 is moved in first direction 70 (accelerate), the spring force Fs within compression springs 550 and 554 increases as springs 550 and 554 are compressed between brake pad 560 and housing 502. The increased force Fs urges brake pad 560 toward or into actuator 580. More specifically, brake pad arms 563 and 564 are wedged against actuator wedge surfaces 595 and 596, respectively.

The effect of the depression of the pedal arm 50 leads to an increasing normal force exerted by the arm contact surfaces 566 and 567 against housing braking surfaces 531 and 532. A friction force between the arm contact surfaces 566 and 567 and housing braking surfaces 531 and 532 is defined by the coefficient of dynamic friction multiplied by the normal force. As the normal force increases with increasing applied force at the pedal arm, the friction force accordingly increases. The driver feels this increase in his/her foot at pedal arm 50. The friction force opposes the applied force as the pedal is depressed and subtracts from the spring force as the pedal is returned toward the idle position.

Movement of actuator 580 within housing 502 is guided in a linear manner along an axis parallel to the length of housing 502 by actuator rails 598 being engaged with and sliding in housing channels 515.

When force on pedal arm 50 is reduced or pedal arm 50 is released and moves in direction 72, the opposite effect is present. Pedal arm 50 rotates upwardly and springs 550 and 554 decompress to urge brake pad 560 to move actuator 580 in direction 578 outwardly from housing 502. Springs 550 and 554 can return pedal arm 50 to a rest or idle position.

As actuator 580 moves in direction 578, the frictional or drag forces between arm contact surfaces 566 and 567 and housing braking surfaces 531 and 532 are reduced. As actuator 580 moves in direction 578, arms 563 and 564 decrease the pressure applied to walls 505. While the pressure on walls 505 is decreased, it does not drop to zero such that some drag or friction occurs between contact surfaces 566 and 567 and braking surfaces 531 and 532 as pedal 50 moves.

As brake pad 560 and actuator 580 move in direction 578, a slight wedging effect will still occur between brake pad 560 and actuator 580. More specifically, arm angled surfaces 568 and 570 of brake pad 560 are pressed into contact with wedge surfaces 595 and 596 of actuator 580 forcing arms 563 and 564 to bend and be moved outwardly toward each other. In this manner, a low amount of drag force is generated between contact surfaces 566 and 567 and braking surfaces 531 and 532, respectively, as actuator 580 moves in direction 278.

The resulting drag between arm contact surfaces 566 and 567 and housing braking surfaces 531 and 532 slows the movement of pedal arm 50 in direction 72 and can be felt by the person touching pedal arm 50. Further reduction in force on pedal arm 50 results in pedal arm 50 moving to an idle engine position.

The sliding motion of actuator 580 into brake pad 560 is gradual and can be described as a “wedging” effect that either increases or decreases the force urging arm contact surfaces 566 and 567 into housing braking surfaces 531 and 532. This force is directionally dependent and the force has hysteresis.

The force required to depress the pedal is not equal to the force required to return the pedal. More force is required to depress the pedal due to the friction generated between arm contact surfaces 566 and 567 and housing braking surfaces 531 and 532 than is required to extend the pedal. The forces required to extend the pedal are supplied by the decompression of springs 550 and 554. Hysteresis in pedal arm force is desirable in that it approximates the feel of a conventional mechanically-linked accelerator pedal.

The friction force adds to the spring force during depression of the pedal arm and the friction force subtracts from the spring force as the pedal is released or returned toward its idle position.

The operation the magnet assembly 32 and Hall effect sensor 44 of pedal assembly 20 with friction generating assembly 500 would be the same as previously described for the operation of pedal assembly 20 and thus the earlier description is hereby incorporated herein by reference.

The graph of pedal force versus pedal travel distance for the accelerator pedal assembly 20 of FIG. 1 using the friction generating assembly 500 of FIGS. 12-14 would be the same as shown in FIG. 11.

### Second Alternative Friction Generating Assembly Embodiment

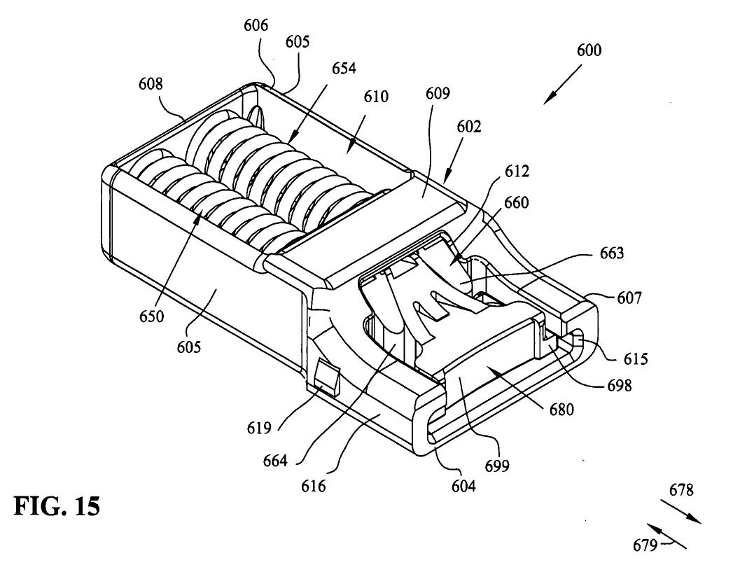

Another alternative embodiment of a friction generating assembly or cartridge or module 600 is shown in FIGS. 15-17. Friction generating assembly 600 is adapted to be mounted in friction generating assembly cavity 140 (FIG. 5). Friction generating assembly 600 includes a brake housing or cartridge or module 602 within which at least the following components are mounted: springs 644 and 650; brake pad 660; and actuator 680. Friction generating assembly 600 is similar to friction generating assembly 500.

Brake housing 602 is generally rectangular in shape and has a bottom wall 604 that adjoins parallel opposed spaced apart side walls 605. A top wall or cross-member 609 adjoins a portion of side walls 605 and connects the top of side walls 605. Top wall 609 is opposed to and spaced apart from bottom wall 604. Top wall 609 adds additional strength to side walls 605. Brake housing 602 defines opposed ends 606 and 607. End wall 608 is located at end 606 and is perpendicular to bottom wall 604 and side walls 605.

Brake housing 602 may be formed from any suitable material such as injection molded plastics and, more specifically, from plastics having a high yield strength.

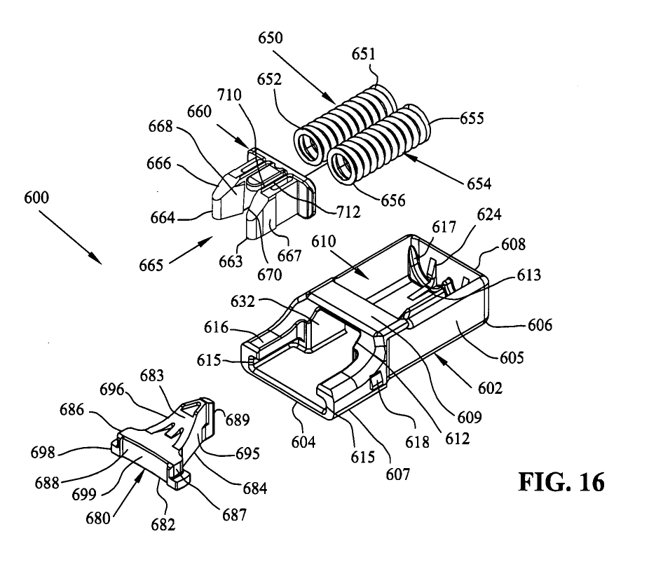

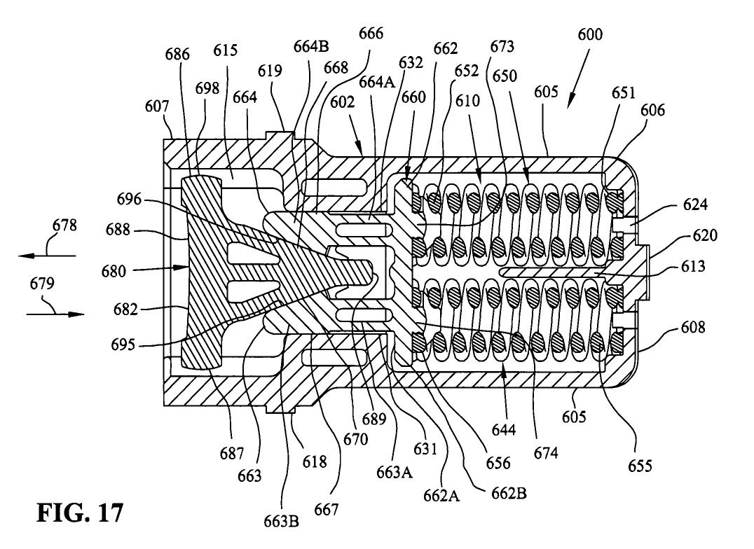

Walls 604, 605, 608 and 609 define an interior chamber or cavity 610. Cavity 610 opens upwardly. Walls 604, 605 and 609 define an opening 612 that faces toward end 607. A pair of U-shaped ribs 617 (FIG. 16) extend from end wall 608 partially into cavity 610. A pair of generally circular, spaced-apart and parallel bosses 624 (FIGS. 16 and 17) also extend outwardly from end wall 608 partially into cavity 610. A center rib 613 extends upwardly from bottom wall 604 into cavity 610 and between and spaced from bosses 624.

A portion of the interior surface of each of the side walls 605 extends or protrudes inwardly to define interior opposed flat braking surfaces 631 and 632. Braking surfaces 631 and 632 are parallel and opposed to each other and adjoin opening 612. Brake surfaces 631 and 632 may be formed of either the same material as walls 605 or may be formed from a material having an increased coefficient of friction.

Brake housing 602 further has a pair of opposed generally C-shaped portions 616 (FIG. 16) that define respective slots or grooves 615 in opposite sides of housing 602. Portions 616 extend from side walls 605 toward end 607 and are parallel and opposed. A pair of locking tabs or fingers 618 and 619 (FIGS. 15-17) extend outwardly from each of the portions 616 and another locking tab or finger 620 (FIG. 17) extends outwardly from end wall 608. A pair of conically-shaped bosses 624 extend from end wall 608 into cavity 610.

With continued reference to FIGS. 15-17, friction generating assembly 600 further includes a brake pad 660 (FIG. 16) that is configured for engagement with housing braking surfaces 631 and 632. Brake pad 660 is generally U-shaped and has a central body 662 with opposed faces 662A and 662B. A pair of elongated, parallel, spaced-apart arms 663 and 664 extend outwardly perpendicularly from surface 662A. Arms 663 and 664 together with the central body 662 define a substantially U-shaped member. Arms 663 and 664 are separated by a gap or slot 665. Arm 663 has a narrow or thin end 663A and a wide or thick end 663B. Diametrically opposed arm 664 has a narrow or thin end 664A and a wide or thick end 664B. Narrow ends 663A and 664A allow arms 663 and 664 to slightly bend or flex when forces normal to the length of arms 663 and 664 are applied.

Arm 663 has a flat, non-angled outward-facing contact surface 667 and an inward-facing flat angled surface 670. Arm 664 has a flat, non-angled outward-facing contact surface 666 and an inward-facing flat angled surface 668. Angled surfaces 668 and 670 are juxtaposed and face each other prior to being assembled in brake housing 602. Surfaces 668 and 670 diverge outwardly from each other in the direction of housing end 604.

After brake pad 660 is mounted in brake housing 602, arm contact surface 666 is adjacent to and adapted for engagement with housing braking surface 632 while contact arm surface 667 is adjacent to and can be engaged with housing braking surface 631.

A pair of spaced-apart and parallel barrel-shaped bosses or projections 673 and 674 extend outwardly perpendicularly from brake pad surface 662B in a direction that is opposite the direction of arms 663 and 664.

Brake pad 660 can be formed from any suitable material adapted to provide a desired coefficient of friction for contact surfaces 666 and 667.

A pair of coil springs 650 and 654 are mounted inside cavity 610. Spring 650 defines opposed ends 651 and 652. Spring 654 defines opposed ends 655 and 656. Springs 650 and 654 are compressed between end wall 608 and brake pad 660. Springs 650 and 654 bias pedal arm 50 (FIG. 1) outwardly to a rest or idle position. Spring ends 651 and 655 are retained in housing 602 by resting on U-shaped ribs 617 and mounting over bosses 624. Bosses 624 extend partially into springs 650 and 654. Spring ends 652 and 656 are retained by brake pad 660 by mounting over bosses or projections 673 and 674. Bosses 673 and 674 extend partially into springs 650 and 654.

Two springs are used for redundancy reasons. If one spring were to fail, another would still be operational. This redundancy is provided for improved reliability, allowing one spring to fail or fatigue without disrupting the biasing function. It is useful to have redundant springs and for each spring to be capable on its own of returning the pedal arm to its idle position. Other types of springs could also be used such as leaf springs or torsion springs.

With continued reference to FIGS. 15-17, actuator 680 is mounted in brake housing opening 612 adjacent to and in contact with brake pad 660. Actuator 680 defines a central body 682. Body 682 defines a top 683, bottom 684, side 686, side 687, front 688 and back 689.

A wedging surface 696 (FIG. 16) is defined on side 686 and a wedging surface 695 (FIG. 16) is located on opposed side 687 of actuator 680. Wedging surface 695 is substantially parallel and adjacent to and can be pressed into contact with brake pad angled surface 670. Wedging surface 696 is substantially parallel and adjacent to and can be pressed into contact with brake pad angled surface 670. Wedge surfaces 695 and 696 diverge outwardly from each other in a generally V-shaped orientation in the direction of actuator end 688.

Guide rail 698 extends outwardly from a portion of each of the opposed sides 686 and 687. Rails 698 are located toward front 688 and are oriented in an opposed, parallel, diametrically opposed relationship. Rails 698 are mounted for sliding movement within channels 615 of housing 602. Rails 698 slide within channel 615 as actuator 680 is moved. Rails 698 retain actuator 680 to housing 602 and guide movement of actuator 680 in a linear manner as actuator 680 moves in directions 678 and 679. Actuator 680 can be moved further into housing 602 in direction 679 and can be moved further out of housing 602 in direction 678.

An elongated planar camming surface 699 extends along front 688 of actuator 680 and is adapted to be engaged by cam lobe 62 of pedal arm 50 (FIG. 4) after assembly 600 is mounted to housing 100 (FIG. 4).

Friction generating assembly 600 is adapted to be mounted in friction generating assembly cavity 140 (FIG. 5) as a single, separate module or modular unit and further is adapted to replace friction generating assembly 200. If replaced in the embodiment of FIG. 5, friction generating assembly 600 would be placed in friction generating cavity 140 and housing 602 pressed downwardly such that locking tabs 618 and 619 slide against side walls 103 and 104 and locking tab 620 slides against front wall 106. As housing 602 is pressed further into friction generating cavity 140, it reaches a stop position where locking tab 618 snaps into hole 144, locking tab 619 snaps into hole 146 and locking tab 620 snaps into hole 142. Friction generating assembly 600 is then securely retained to housing 100 in friction generating assembly cavity 140.

The use of friction generating assembly 600 has many advantages. Because friction generating assembly 600 is a modular self-contained friction generating unit, it can be used with a wide variety of housing 100 and pedal arm 50 shapes and sizes. For example, different vehicles may require slightly different housing and pedal arm designs due to the configuration of vehicle floors, vehicle firewalls, mounting holes, pedal locations and connector mounting locations.

Because friction generating assembly 600 is a modular self-contained friction generating unit, the design of friction generating assembly 600 can remain constant while the shape and size of housing 100 and pedal arm 50 is customized for each vehicle application as necessary.

Operation with Second Alternative Friction Generating Assembly Embodiment

Pedal assembly 20 can be operated using friction generating assembly 600 in a similar manner as previously described for friction generating assembly 200. Friction generating assembly 600 can replace friction generating assembly 200 in FIGS. 4-6. The operation of friction generating assembly 600 will now be explained in conjunction with FIGS. 4-6 assuming that friction generating assembly 600 has replaced friction generating assembly 200 in FIGS. 4-6.

Turning now to FIGS. 4 and 17, pedal arm 50 can be depressed by a user and move in a first direction 70 (accelerate) or pedal arm 50 can be released and move in the other direction 72 (decelerate). As pedal arm 50 is depressed and moves in direction 70, pedal arm 50 rotates downwardly and forces pedal arm cam lobe 62 to be engaged with or press on actuator camming surface 699. Cam lobe 62 and camming surface 699 translate the rotary motion of pedal arm 50 into linear motion of actuator 680. As pedal arm 50 is depressed further, actuator 680 is moved in direction 679 in the direction of springs 640 and 650 forcing actuator wedge surfaces 695 and 696 into contact with brake pad angled surfaces 668 and 670 and forcing arms 663 and 664 to bend and be moved outwardly in opposite directions away from each other generally perpendicular to the motion of actuator 680. Actuator 680 forces or wedges arms 663 and 664 against the outside walls 605 of brake housing 602.

The outward motion of arms 663 and 664 forces contact surfaces 666 and 667 thereof into further engagement with housing braking surfaces 631 and 632 and increases the normal contact or frictional forces between arm contact surfaces 666, 667 and housing interior braking surfaces 631, 632. The frictional force generated between brake pad contact surfaces 666 and 667 and housing braking surfaces 631 and 632 increases as actuator 680 is moved further in direction 679. Moreover, as actuator 680 is moved further, the force required to move actuator 680 increases as actuator 680 is moved further into housing 602.

The resulting drag between arm contact surfaces 666 and 667 and housing interior braking surfaces 631 and 632 resists the movement of pedal arm 50 in direction 70 and can be felt by the person or user depressing pedal arm 50 with their foot.

At the same time that pedal arm 50 is moved in first direction 70 (accelerate), the spring force Fs within compression springs 650 and 654 increases as springs 650 and 654 are compressed between brake pad 660 and housing 602. The increased force Fs urges brake pad 660 toward or into actuator 680. More specifically, brake pad arms 663 and 664 are wedged against actuator wedge surfaces 695 and 696, respectively.

The effect of the depression of the pedal arm 50 leads to an increasing normal force exerted by the arm contact surfaces 666 and 667 against housing interior braking surfaces 631 and 632. A friction force between the arm contact surfaces 666 and 667 and housing interior braking surfaces 631 and 632 is defined by the coefficient of dynamic friction multiplied by the normal force. As the normal force increases with increasing applied force at the pedal arm, the friction force accordingly increases. The driver feels this increase in his/her foot at pedal arm 50. The friction force opposes the applied force as the pedal is depressed and subtracts from the spring force as the pedal is returned toward the idle position.

Movement of actuator 680 within housing 602 is guided in a linear manner along an axis parallel to the length of housing 602 by actuator rails 698 being engaged with and sliding in housing channels 615.

When force on pedal arm 50 is reduced or pedal arm 50 is released and moves in direction 72, the opposite effect is present. Pedal arm 50 rotates upwardly and springs 650 and 654 decompress to urge brake pad 660 to move actuator 680 in direction 678 outwardly from housing 602. Springs 650 and 654 can return pedal arm 50 to a rest or idle position.

As actuator 680 moves in direction 678, the frictional or drag forces between arm contact surfaces 666 and 667 and housing interior braking surfaces 631 and 632 are reduced. As actuator 680 moves in direction 678, arms 663 and 664 decrease the pressure applied to walls 605. While the pressure on walls 605 is decreased, it does not drop to zero such that some drag or friction occurs between contact surfaces 666 and 667 and braking surfaces 631 and 632 as pedal 50 moves.

As brake pad 660 and actuator 680 moves in direction 678, a slight wedging effect will still occur between brake pad 660 and actuator 680. More specifically, angled surfaces 668 and 670 of brake pad 660 are pressed into contact with wedge surfaces 695 and 696 of actuator 680 forcing arms 663 and 664 to bend and be moved outwardly toward each other. In this manner, a low amount of drag force is generated between arm contact surfaces 666 and 667 and housing interior braking surfaces 631 and 632, respectively, as actuator 680 moves in direction 678.

The resulting drag between arm contact surfaces 666 and 667 and housing interior braking surfaces 631 and 632 slows the movement of pedal arm 50 in direction 72 and can be felt by the person touching pedal arm 50. Further reduction in force on pedal arm 50 results in pedal arm 50 moving to an idle engine position.

The sliding motion of actuator 680 into brake pad 660 is gradual and can be described as a “wedging” effect that either increases or decreases the force urging arm contact surfaces 666 and 667 into housing interior braking surfaces 631 and 632. This force is directionally dependent and the force has hysteresis.

The force required to depress the pedal is not equal to the force required to return the pedal. More force is required to depress the pedal due to the friction generated between arm contact surfaces 666 and 667 and housing interior braking surfaces 631 and 632 than is required to extend the pedal. The forces required to extend the pedal are supplied by the decompression of springs 650 and 654. Hysteresis in pedal arm force is desirable in that it approximates the feel of a conventional mechanically-linked accelerator pedal.

The friction force adds to the spring force during depression of the pedal arm and the friction force subtracts from the spring force as the pedal is released or returned toward its idle position.

The operation the magnet assembly 32 and Hall effect sensor 44 of pedal assembly 20 with friction generating assembly 600 would be the same as previously described for the operation of pedal assembly 20.

The graph of pedal force versus pedal travel distance for the accelerator pedal assembly 20 of FIG. 1 using the friction generating assembly 600 of FIGS. 15-17 would be the same as shown in FIG. 11.

### CONCLUSION

Numerous variations and modifications of the embodiments described above may be effected without departing from the spirit and scope of the novel features of the invention. It is to be understood that no limitations with respect to the specific system illustrated herein are intended or should be inferred. It is, of course, intended to cover by the appended claims all such modifications as fall within the scope of the claims. For example, while the elements of the friction generating assemblies have been described as comprising part of a separate module or cartridge adapted to be snapped into the pedal housing, it is understood that the invention likewise encompasses the use of those elements as part of a friction generating assembly which is unitary or molded with the pedal housing.

What is claimed is:

1. A pedal assembly comprising:
a pedal housing;
a pedal arm coupled to the pedal housing;
a brake housing associated with the pedal housing;
a brake pad associated with the brake housing, movement of the pedal arm causing movement of the brake pad;
a magnet associated with the pedal arm; and
a sensor associated with the pedal housing and positioned in proximity to the magnet, the sensor being responsive to movement of the magnet for generating an electrical signal representative of the position of the pedal arm.

2. The pedal assembly in accordance with claim 1 wherein the brake housing defines a braking surface and the brake pad defines a contact surface that is substantially complementary to the braking surface, the contact surface being adapted to be engaged with the braking surface.

3. The pedal assembly in accordance with claim 1 wherein a spring is associated with the brake pad for urging the pedal arm to a rest position.

4. The pedal assembly in accordance with claim 1 wherein an actuator is coupled between the pedal arm and the brake pad.

5. The pedal assembly in accordance with claim 2 wherein the brake pad has a pair of arms.

6. The pedal assembly in accordance with claim 5 wherein a slot is defined between the arms.

7. The pedal assembly in accordance with claim 6 wherein a wall extends from the brake housing.

8. The pedal assembly in accordance with claim 7 wherein opposed surfaces of the wall define respective opposed braking surfaces.

9. The pedal assembly in accordance with claim 8 wherein the arms engage the opposed surfaces of the wall respectively.

10. The pedal assembly in accordance with claim 1 wherein a kickdown device is coupled to the pedal arm.

11. A pedal assembly comprising:
a housing;
a pedal arm coupled to the housing;
a friction generating assembly coupled with the housing, the friction generating assembly including:
an actuator mounted adjacent the pedal arm, the actuator being adapted to be moved by the pedal arm as the pedal arm is depressed;
a brake pad having at least one contact surface, the brake pad operable to be moved by the actuator, the contact surface engaging a braking surface such that friction is generated between the contact surface and the braking surface;
a spring contacting the brake pad for biasing the pedal arm; and
a sensor responsive to movement of the pedal arm for providing an electrical signal that is representative of pedal position.

12. The pedal assembly in accordance with claim 11 wherein the housing defines a braking surface, the contact surface on the brake pad being adapted to be engaged with the braking surface.

13. The pedal assembly in accordance with claim 11 wherein a spring is set between the brake pad and the housing.

14. The pedal assembly in accordance with claim 11 wherein the actuator is coupled between the pedal arm and the brake pad.

15. The pedal assembly in accordance with claim 11 wherein the sensor includes a magnet coupled to the pedal arm and a magnetic sensor positioned proximate the magnet.

16. The pedal assembly in accordance with claim 12 wherein the housing has a wall, the braking surface being defined by the wall.

17. The pedal assembly in accordance with claim 16 wherein the brake pad has a pair of arms and the contact surface is defined on the arms.

18. The pedal assembly in accordance with claim 17 wherein the wall is an interior central wall and opposed sides of the wall define respective opposed braking surfaces, each of the arms defining an inner surface defining the contact surface, the actuator being adapted to flex the arms inwardly into contact with the opposed braking surfaces of the wall.

19. The pedal assembly in accordance with claim 17 wherein the wall of the housing is defined by an exterior wall, each of the arms define an outer contact surface, the actuator being adapted to flex the arms and the respective outer contact surfaces thereof outwardly into contact with the wall of the housing.

20. A pedal assembly comprising:
a housing defining a cavity;
a pedal arm rotatably coupled to the housing;
a separate friction generating module adapted to be mounted in the cavity, the friction generating module including:
a brake pad having a contact surface that is adapted to contact a braking surface of the friction generating module;
at least one spring adapted to abut against the brake pad; and
an actuator adapted to engage against the brake pad, movement of the pedal arm causing the actuator to move the brake pad into contact with the braking surface.

21. The pedal assembly of claim 20 wherein the brake pad has a pair of arms, the contact surface being defined on the arms.

22. The pedal assembly of claim 21 wherein the braking surface is defined on an interior central wall of the friction generating module and the actuator is adapted to flex the arms of the brake pad inwardly into contact with opposed sides of the wall.

23. The pedal assembly of claim 21 wherein the braking surface is defined on an interior peripheral wall of the friction generating module and the actuator is adapted to flex the arms of the brake pad outwardly into contact with the brake surfaces defined by the wall.

24. A pedal assembly comprising:
a pedal housing;
a pedal arm rotatably coupled to the pedal housing;
a sensor responsive to movement of the pedal arm for providing an electrical signal that is representative of a position of the pedal arm;
a friction generating assembly associated with the pedal housing, the friction generating assembly including:
a brake housing defining at least one braking surface;
a brake pad associated with the brake housing and defining at least one contact surface, the brake pad being operable for movement in response to movement of the pedal arm, the contact surface being adapted for engagement with the braking surface for generating friction;
at least one spring in the brake housing; and
an actuator located between the pedal arm and the brake pad, the actuator pressing on the brake pad when the pedal arm is depressed.

25. The pedal assembly in accordance with claim 24 wherein the pedal housing defines a cavity and the brake housing is a separate cartridge adapted to be mounted in the cavity.

26. The pedal assembly in accordance with claim 25 wherein the brake housing has at least one tab adapted to allow the brake housing to be retained in the cavity of the pedal housing.

27. The pedal assembly of claim 25 wherein the cartridge includes at least the actuator, brake pad, and spring mounted therein.

28. The pedal assembly of claim 27 wherein the pedal arm is adapted to engage the actuator and the actuator is adapted to engage the brake pad and the brake pad is adapted to engage the spring.

29. The pedal assembly of claim 27 wherein the cartridge defines a central inner wall including respective opposed sides defining respective opposed braking surfaces, the brake pad including respective arms defining respective contact surfaces and adapted to be flexed inwardly by the actuator into contact with the opposed braking surfaces of the wall for generating friction.

30. The pedal assembly of claim 27 wherein the cartridge defines a peripheral interior wall, the brake pad including respective arms defining respective contact surfaces and adapted to be flexed outwardly by the actuator into contact with the peripheral interior wall for generating friction.
